(19) United States
(12) Patent Application Publication
(10) Pub. No.: US 2006/0190435 A1
(43) Pub. Date: Aug. 24, 2006

(54) Document retrieval using behavioral attributes

(75) Inventors: Niklas Heidloff, Salzkotten (DE); Michael R. O'Brien, Westford, MA (US); Gregory Robert Klouda, Lancaster, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: International Business Machines Corporation, Armonk, NY (US)

(21) Appl. No.: 11/065,471

(22) Filed: Feb. 24, 2005

(51) Int. Cl. G06F 17/30

(52) U.S. Cl. 707/3

(57) ABSTRACT

Described is a method for retrieving a user document using behavioral attributes associated with the user document. One or more relevant documents in a user library are determined in response to a text search of documents in the library. Each relevant document has a text relevance. A behavioral relevant is determined for each of the relevant documents based upon an associated behavioral attribute. A user relevance is determined for each of the relevant documents in response to the text relevance and the behavioral relevance of each relevant document. A list of relevant documents is generated and ordered according to user relevance.

### FIELD OF THE INVENTION

The invention relates generally to document retrieval. In particular, the invention relates to a method for retrieving documents using attributes based on user behavioral patterns.

### BACKGROUND OF THE INVENTION

Information retrieval has become more important in recent years due to easy access to the Internet and the continuing development of Internet search engines. Users can search for online information by entering subject search terms or phrases in various combinations. Search results can be limited, for example, by specifying resource date ranges and the number of occurrences of the terms or phrases in the resource. A user performing such searches does not necessarily know if a suitable resource or web page for the requested subject exists or where on the Internet the information may be found. Results provided by the search engines typically include a listing of links to web pages previously unknown to the user.

Personal information management applications such as email applications maintain and manage information and documents specific to a user. Techniques for retrieving information through personal information management applications are significantly different that those employed by Internet search engines. With the exception of unread documents, users generally know that a document exists containing the desired information. In some instances, the user has previously read the document many times. Unfortunately, performing a text search on the document library using terms or phrases can result in a large number of unrelated documents which can mask the presence of the desired document.

What is needed is a method for retrieving user documents having greater relevance to the user than currently possible using conventional document searches. The present invention satisfies this need and provides additional advantages.

### SUMMARY OF THE INVENTION

In one aspect, the invention features a method for retrieving a user document. At least one relevant document in a user library is determined in response to a text search of a plurality of documents in the user library. Each of the relevant documents has a text relevance. A behavioral relevance of the relevant documents is determined based upon a behavioral attribute of the relevant documents. A user relevance of the relevant documents is determined in response to the text relevance and the behavioral relevance of the relevant documents.

In another aspect, the invention features a computer program product for retrieving a user document. The computer program product code includes a computer useable medium having program code. The program code includes program code for determining at least one relevant document in a user library in response to a text search of a plurality of documents in the user library. Each of the relevant documents has a text relevance. The program code of the computer useable medium also includes program code for determining a behavioral relevance of the relevant documents based upon a behavioral attribute of the relevant documents and program code for determining a user relevance of the relevant documents in response to the text relevance and the behavioral relevance of the relevant documents.

In another aspect, the invention features a computer data signal embodied in a carrier wave for retrieving a user document. The computer data signal includes program code for determining at least one relevant document in a user library in response to a text search of a plurality documents in the user library. Each of the relevant documents has a text relevance. The program code of the computer data signal also includes program code for determining a behavioral relevance of the relevant documents based upon a behavioral attribute of the relevant documents and program code for determining a user relevance of the relevant documents in response to the text relevance and the behavioral relevance of the relevant documents.

In another aspect, the invention features an apparatus for retrieving a user document. The apparatus includes means for determining at least one relevant document in a user library in response to a text search of a plurality documents in the user library. Each of the relevant documents has a text relevance. The apparatus also includes means for determining a behavioral relevance of the relevant documents based upon a behavioral attribute of the relevant documents and means for determining a user relevance of the relevant documents in response to the text relevance and the behavioral relevance of the relevant documents.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 is an illustration of a graphical user interface displaying a list of documents provided by performing a method for retrieving a user document according to the invention.

FIG. 2 is a graphical presentation of the relative attribute importance of three behavioral attributes and the relative importance of attribute values for each behavioral attribute.

FIG. 3 is a flowchart representation of an embodiment of a method for retrieving a user document according to the invention.

FIG. 4 depicts an example of the processing of emails during the performance of the method of FIG. 3.

### DETAILED DESCRIPTION

In brief overview the present invention relates to a method for retrieving a user document. The method can be implemented as a feature of applications managing documents of a variety of types. For example, the method can be integrated into a variety of email applications as a post query filter implemented upon completion of a text search feature. The method takes advantage of user behavioral attributes that are normally employed when a user views and sorts the results of a standard search for documents in a user library such as an email mailbox. The method includes determining relevant documents from a text search of documents in the user library. Each of the relevant documents has a text relevance. One or more behavioral attributes are examined for each relevant document to determine a behavioral relevance of each relevant document. A user relevance is determined for each of the relevant documents in response to the respective text relevance and behavioral relevance. A user is presented with a list of relevant documents based upon the user relevance. The list can be ordered or otherwise arranged according to user relevance. Consequently, the user viewing the list of relevant documents can quickly find the desired document with less time and effort than is generally required when viewing the results of a standard text-based search.

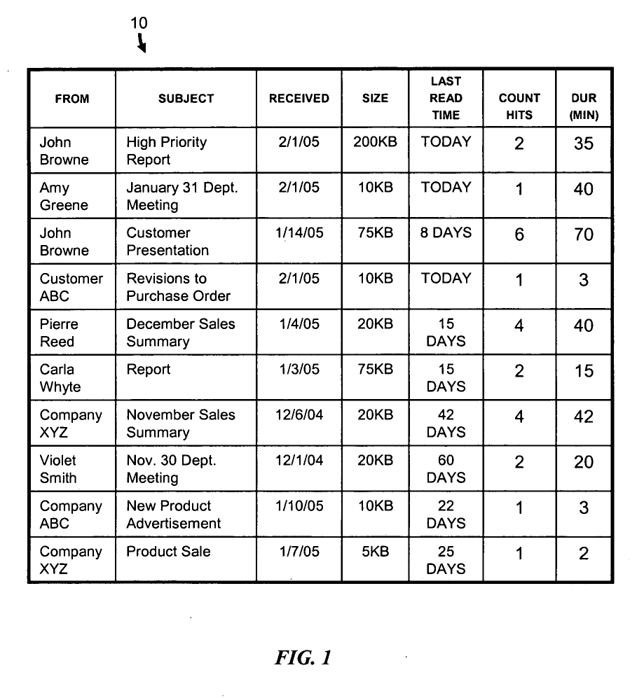

FIG. 1 is an illustration of a graphical user interface (GUI) 10 displaying a list of documents arranged according to a user relevance. User relevance is determined by performing an embodiment of a method for retrieving a user document according to the invention. Although the description herein is limited to email documents, it should be recognized that the method can be adapted for other document types. Each identified email is displayed with sender, subject line, date of receipt and size information. Also shown are three behavioral attributes: “LAST READ TIME”, “COUNT HITS” and “DUR.” (i.e., “DURATION”). The value for “COUNT HITS” represents the number of times the document was opened and the value for “DUR” represents the total length of time that the document remained open. The emails are listed in descending order of user relevance such that emails at the top and bottom of the GUI 10 have the highest and lowest user relevance, respectively, of the listed emails.

In this example, the user requests a full-text search of the body of each email in a personal email mailbox. A number of emails satisfying the full-text search criteria are identified and a post query filter (i.e., optimizer) is applied. The post query filter processes the results of the full-text search in a way that is similar to a behavioral pattern a user employs with access only to the “raw” search results. For example, an email read last week is generally more important than an email read a year ago. In another example, an email that is read many times is typically more important to the user than an email read only once or twice. By way of example, a frequently read email can be an email that summarizes an important project or an email that includes a checklist. In web-based email applications, the duration for which an email remains “open” is also an indicator of the importance of the email to the user. However, in rich client email applications such as IBM Lotus Notes™ or Microsoft Outlook™, duration is less useful as an indicator of user relevance because users can have multiple emails open at one time. For example, each email may be open as a separate window so that only the window on top is visible to the user. Thus an email no longer being read can remain open for a substantial time while hidden from view.

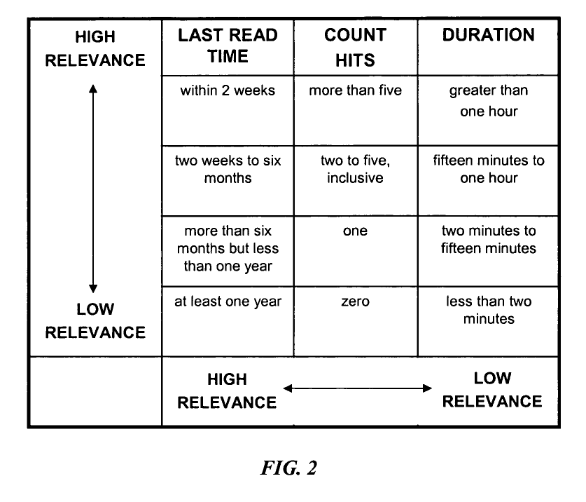

The method of the invention is implemented as a post query filter that is executed upon completion of a full-text search. The post query filter examines one or more of the behavioral attributes associated with each email identified in the full-text search results. FIG. 2 presents the relative importance for each of three behavioral attributes arranged vertically according to their relevance values. The behavioral attributes include “last read time” which indicates the last time the user opened the email. Other behavioral attributes include count hits” which is an integer value greater than or equal to zero that indicates the number of time an email document has been opened and “duration” which indicates the accumulated time a document has remained opened. An email that is only opened for short times can have a large duration value if the number of times it has been opened is large. The relevance value for each behavioral attribute is determined according to one of the value ranges in the respective column. For example, a value of the count hits attribute indicating that the email has been opened five or more times results in the assignment of the highest possible behavioral relevance value for the attribute whereas lower count hits values result in lower behavioral relevance values.

In the current example, last read time is the most important behavioral attribute and duration is the least important behavioral attribute. In particular, the determination that an email has been opened within two weeks is a more important indicator of user relevance than a determination that the email was opened more than five times. A determination that the email was opened more than five times is more important to user relevance than the time during which the document remained open, even if the document was open for more than one hour. Thus, the highest relevance value for the last read time attribute exceeds the highest relevance value for the count hits attribute. Similarly, the highest relevance value for the count hits attribute exceeds the highest relevance value for the duration attribute. The behavioral relevance value determined for the email is a combination of the relevance values determined for each of the behavioral attributes.

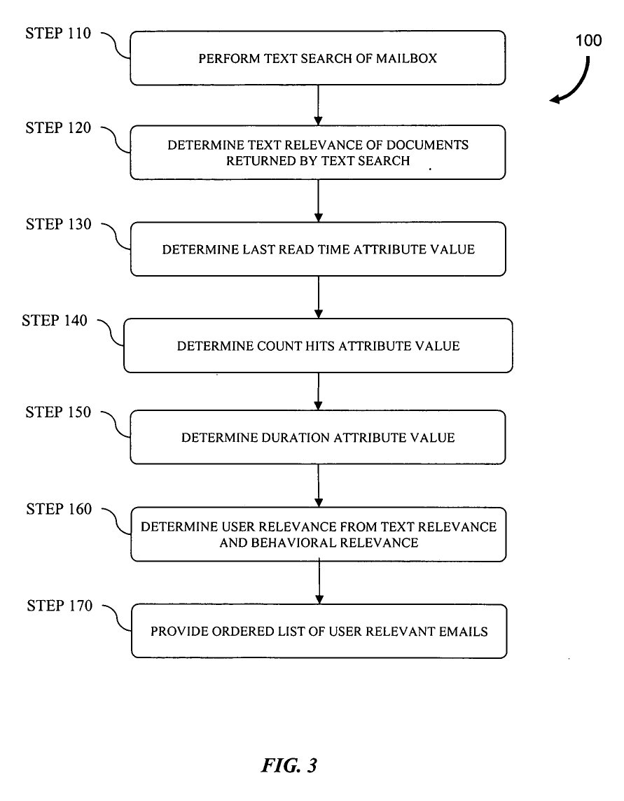

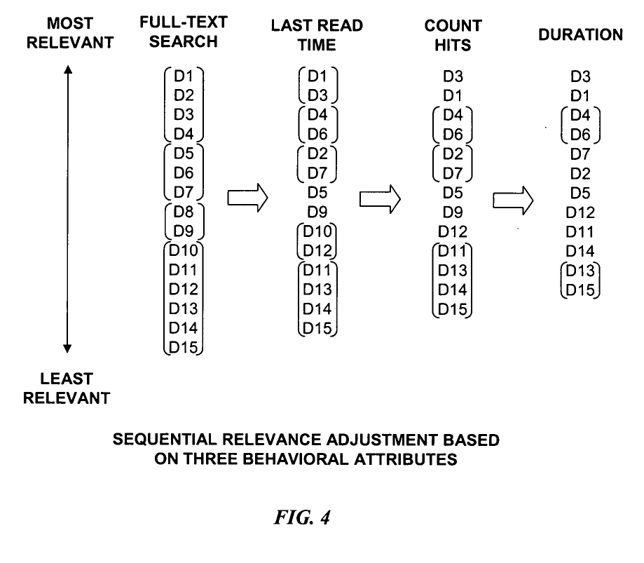

FIG. 3 shows a flowchart representing an embodiment of the method 100 employed by the post query filter. FIG. 4 shows an example of the processing of emails of a full-text search during the application of the post query filter. Individual email documents are designated by the letter “D” followed by an integer value. Each column represents the relevance of the emails at a specific time during the search and post query process. The user performs (step 110) a full-text search of the content of previously viewed emails in an email mailbox using, for example, a search feature provided in a commercially available email application. In one embodiment, the text search is limited to a particular document field of the emails such as the subject line or the message body. A text relevance of each document identified in the results of the search is determined (step 120). For example, the text relevance can be a numerical value that is based on the number of time one or more search terms occur in a document.

In this example, the user provides at least one word or phrase for the search and requests (or accepts a default value) that the results be limited to ten emails. Due to processing by the post query filter, it is possible that one or more emails provided by the full-text search may be deemed to have no behavioral relevance and thus not be relevant to the user. Thus the fill-text search can first be executed to identify ten emails. If subsequent processing by the post query filter results in the elimination of one or more text relevant emails, the full-text search is again executed again to identify more than ten text relevant emails and the post query filter is again applied. The process can be repeated until the number of text relevant emails remaining after the last application of the post query filter matches the number of emails requested by the user. Alternatively, the number of text relevant emails returned by the full-text search can be automatically increased to be substantially larger than the requested number. The illustrated example shows an instance in which the requested number of emails is ten but the full-text search identifies fifteen emails.

The text relevant emails identified by the full-text search are listed vertically in descending order of text relevance. The sequential operation of stages of the post query filter is shown as a left to right progression. Brackets indicate emails having the same relevance at the respective processing stage. For example, emails D1, D2, D3 and D4 are determined to have the highest relevance of all text relevant emails. Subsequently, the last time each email was opened by the user is determined (step 130) for all fifteen emails and the relevance is reordered accordingly. In this example, two of the high text relevant emails (D1 and D3) are determined to be of equal and greatest importance based on last read time. Email D4 was read more recently than email D2 therefore email D4 is ranked above email D2 in the last read time column. For example, if email D4 was last read one week ago and email D2 was last read one month ago, then the application of the attribute relevance rules as shown in FIG. 2 results in email D4 receiving a higher relevance adjustment than email D2. Similar reordering occurs for emails in the other text relevant email groupings. The number of identified emails is reduced to fourteen because one of the emails (D8) was determined to have no relevance because it was read too long ago. For instance, email D8 can be an email that was last read more than one year ago.

Processing continues by determining (step 140) the number of times each of the fourteen emails was read and adjusting the relevance of each email accordingly. Email D3 is now deemed more relevant than email D1 because email D3 was read more often and receives a higher adjustment according to the attribute relevance rules. Email D10 is deemed not relevant because it was never opened and is therefore eliminated from the email listing. For example, email D10 can be an easily identified spam email that the user elected not to open but neglected to delete from the email mailbox.

If the resident email application is web based as described above, the post query filter continues by determining (step 150) the duration, i.e., the sum or “accumulation” of the time each email was open for viewing. The duration for email D9 is less than one minute so it has been eliminated in this stage of the post query filter. The relevance of the remaining twelve emails is adjusted accordingly.

The result of applying the post query filter is a listing of emails according to their user relevance. As described in the example above, the user relevance is determined (step 160) by adjusting the relevance values after sequential examination of behavioral attributes from the most important behavioral attribute (last read time) to the least important behavioral attribute (duration). A list of emails ordered according to user relevance is provided (step 170) to the user. In this example, the list shows the emails arranged in descending order of user relevance as shown in the duration column. Unlike a simple full-text search organized by text relevance, the user does not have to review a large number of emails to find the desired email. Instead, the user typically finds the desired email near or at the top of the listing. Emails with the same user relevance values ((D4 and D6) and (D13 and D15)) can be ordered according to a default criterion or user preference such as alphabetical arrangement by sender or subject line, or according to the time of receipt of the emails. In this example, emails D13 and D15 are not listed in the results because the user only requested a listing of the ten most user relevant emails documents.

Although the method described above is based on a sequential examination of behavioral attributes of documents and adjustments to the relevance values, it should be recognized by those of skill in the art that the method can also be applied in a parallel manner. For example, a behavioral relevance value can be assigned for each behavioral attribute of a document. The resulting behavioral relevance values for each document are then mathematically combined for example, by summing or performing a weighed summation, to provide a user relevance value. Thus there is no intermediate adjustment of behavioral relevance as shown in FIG. 4 for the last read time and count hits columns.

While the invention has been shown and described with reference to specific embodiments, it should be understood by those skilled in the art that various changes in form and detail may be made therein without departing from the spirit and scope of the invention. For example, the above description is based on a limited example of a retrieval of an email document, it should be recognized that the method can be applied to documents generally.

What is claimed is:

1. A method for retrieving a user document, the method comprising:
determining at least one relevant document in a user library in response to a text search of a plurality of documents in the user library, each of the relevant documents having a text relevance;
determining a behavioral relevance of the relevant documents based upon a behavioral attribute of the relevant documents; and
determining a user relevance of the relevant documents in response to the text relevance and the behavioral relevance of the relevant documents.

2. The method of claim 1 wherein the determining of a behavioral relevance comprises determining a behavioral relevance of the relevant documents based upon a plurality of behavioral attributes.

3. The method of claim 1 wherein the determination of at least one relevant document comprises determining the text relevance of the documents in the user library based on a full-text search.

4. The method of claim 1 wherein the determination of at least one text relevant document comprises determining the text relevance of the documents in the user library based on a text search of a document field.

5. The method of claim 1 wherein the behavioral attribute comprises one of a last read time, a number of document openings and a document open duration.

6. The method of claim 1 wherein the document library comprises at least a portion of an email mailbox.

7. The method of claim 1 further comprising generating a list of relevant documents ordered according to the user relevance.

8. A computer program product for retrieving a user document, the computer program product comprising a computer useable medium having embodied therein program code comprising:
program code for determining at least one relevant document in a user library in response to a text search of a plurality of documents in the user library, each of the relevant documents having a text relevance;
program code for determining a behavioral relevance of the relevant documents based upon a behavioral attribute of the relevant documents; and
program code for determining a user relevance of the relevant documents in response to the text relevance and the behavioral relevance of the relevant documents.

9. The computer program product of claim 8 wherein the determination of at least one relevant document comprises determining the text relevance of the documents in the user library based on a full-text search.

10. The computer program product of claim 8 wherein the determination of at least one relevant document comprises determining the text relevance of the documents in the user library based on a text search of a document field.

11. The computer program product of claim 8 wherein the behavioral attribute comprises one of a last read time, a number of document openings and a document open duration.

12. The computer program product of claim 8 further comprising program code for generating a list of relevant documents ordered according to the user relevance.

13. A computer data signal embodied in a carrier wave for retrieving a user document, the computer data signal comprising:
program code for determining at least one relevant document in a user library in response to a text search of a plurality documents in the user library, each of the relevant documents having a text relevance;
program code for determining a behavioral relevance of the relevant documents based upon a behavioral attribute of the relevant documents; and
program code for determining a user relevance of the relevant documents in response to the text relevance and the behavioral relevance of the relevant documents.

14. The computer data signal of claim 13 wherein the determination of at least one relevant document comprises determining the text relevance of the documents in the user library based on a full-text search.

15. The computer data signal of claim 13 wherein the determination of at least one relevant document comprises determining the text relevance of the documents in the user library based on a text search of a document field.

16. The computer data signal of claim 13 wherein the behavioral attribute comprises one of a last read time, a number of document openings and a document open duration.

17. The computer data signal of claim 13 further comprising program code for generating a list of relevant documents ordered according to the user relevance.

18. An apparatus for retrieving a user document, the apparatus comprising:
means for determining at least one relevant document in a user library in response to a text search of a plurality documents in the user library, each of the relevant documents having a text relevance;
means for determining a behavioral relevance of the relevant documents based upon a behavioral attribute of the relevant documents; and
means for determining a user relevance of the relevant documents in response to the text relevance and the behavioral relevance of the relevant documents.

19. The apparatus of claim 18 wherein the means for determining at least one relevant document comprises means for determining the text relevance of the documents in the user library based on a full-text search.

20. The apparatus of claim 18 wherein the means for determining at least one relevant document comprises means for determining the text relevance of the documents in the user library based on a text search of a document field.

21. The apparatus of claim 18 wherein the document library comprises at least a portion of an email mailbox.

22. The apparatus of claim 18 further comprising means for generating a list of relevant documents ordered according to the user relevance.
